(19) United States
(12) Patent Application Publication
(10) Pub. No.: US 2009/0214881 A1
(43) Pub. Date: Aug. 27, 2009

(54) LOW TEMPERATURE CO-FIRED CERAMIC SUBSTRATE HAVING DIFFUSION BARRIER LAYER AND METHOD OF MANUFACTURING THE SAME

(75) Inventors: Myung Whun Chang, Seoul (KR); Jong Myeon Lee, Gwacheon (KR); Soo Hyun Lyoo, Yongin (KR); Ho Sung Choo, Suwon (KR)

Correspondence Address: MCDERMOTT WILL & EMERY LLP, 600 13TH STREET, N.W., WASHINGTON, DC, 20005-3096, US

(73) Assignee: SAMSUNG ELECTRO-MECHANICS CO., LTD.

(21) Appl. No.: 12/388,849

(22) Filed: Feb. 19, 2009

(30) Foreign Application Priority Data
Feb. 25, 2008 (KR) 10-2008-0016735

(51) Int. Cl. B32B 18/00; C03B 29/00

(52) U.S. Cl. 428/433; 156/89.16

(57) ABSTRACT

There is provided a low temperature co-fired ceramic substrate having a diffusion barrier layer to prevent diffusion occurring in a heterojunction during firing and a method of manufacturing the same. A low temperature co-fired ceramic substrate according to an aspect of the invention may include: a first ceramic layer formed of a material having a first dielectric constant; a second ceramic layer formed of a material having a second dielectric constant lower than the first dielectric constant; and a diffusion barrier layer interposed between the first ceramic layer and the second ceramic layer and formed of the first ceramic layer material, the second ceramic layer material, and a barium (Ba) compound, wherein inter-diffusion between the first ceramic layer material and the second ceramic layer material is prevented by using the diffusion barrier layer.

### CROSS-REFERENCE TO RELATED APPLICATIONS

This application claims the priority of Korean Patent Application No. 2008-0016735 filed on Feb. 25, 2008, in the Korean Intellectual Property Office, the disclosure of which is incorporated herein by reference.

### BACKGROUND OF THE INVENTION

1. Field of the Invention

The present invention relates to low temperature co-fired ceramic substrates and a method of manufacturing the same, and more particularly, to a low temperature co-fired ceramic substrate having a diffusion barrier layer to prevent diffusion occurring at a heterojunction during firing, and a method of manufacturing the same.

2. Description of the Related Art

Low temperature co-fired ceramic substrates refer to devices that are manufactured by firing metal electrodes and ceramic substrates at the same time at a low temperature of 1000° C. or less. The low temperature co-fired ceramic (hereinafter, simply referred to as “LTCC”) substrates have generally been used for high frequency communication passive elements.

The LTCC substrate has a high quality factor because of low dielectric loss of a class ceramic material that is mainly used to form a green sheet, and low conductor loss because of high electrical conductivity of internal electrode materials. Thus, the LTCC substrate allows passive elements (R, L, and C) to be embedded into a module.

With the recent trend towards electrical apparatuses having features of small size, light weight, high density, and high reliability, the LTCC substrates having the above-described advantages have been inevitably used to satisfy the requirements, such as high integration, multiple functions, high speed, high output, and high reliability.

Therefore, while the LTCC substrate is manufactured by laminating and connecting a plurality of green sheet ceramic layers to each other, the green sheet ceramic layers having circuits providing different functions therein are laminated onto upper and lower parts to form a predetermined circuit.

In the LTCC substrate that forms the predetermined circuit by laminating the ceramic layers onto the upper and lower parts thereof, unlike different passive elements (R and L), an internal capacitor C is manufactured by printing the lower electrode onto a green sheet, printing a dielectric paste on the lower electrode, and printing an upper electrode on an upper surface of the dielectric paste.

In the process of firing the plurality of ceramic layers forming the LTCC substrate, as shown in FIG. 1, a diffusion layer A is formed at a heterojunction between a first ceramic layer 10 having a high dielectric constant (high-K) and a second ceramic layer 20 having a low dielectric constant (low-K) due to ion diffusion between the first ceramic layer 10 and the second ceramic layer 20.

During the firing process, barium (Ba) of the first ceramic layer 10 is diffused into the second ceramic layer 20, and Si of the second ceramic layer 20 is diffused into the first ceramic layer 10. As a result, the diffusion layer A is formed. When barium of the first ceramic layer 10 having the high dielectric constant is diffused into the second ceramic layer 20 having the low dielectric constant, the dielectric constant of the first ceramic layer 10 is reduced.

### SUMMARY OF THE INVENTION

An aspect of the present invention provides a low temperature co-fired ceramic substrate having a diffusion barrier layer to prevent defect generation at a heterojunction of a high dielectric constant and a low dielectric constant caused by diffusion during firing.

Another aspect of the present invention provides a method of manufacturing a low temperature co-fired ceramic substrate having a diffusion barrier layer to prevent defect generation at a heterojunction of a high dielectric constant and a low dielectric constant c diffusion during firing.

According to an aspect of the present invention, there is provided a low temperature co-fired ceramic substrate including: a first ceramic layer formed of a material having a first dielectric constant; a second ceramic layer formed of a material having a second dielectric constant lower than the first dielectric constant; and a diffusion barrier layer interposed between the first ceramic layer and the second ceramic layer and formed of the first ceramic layer material, the second ceramic layer material, and a barium (Ba) compound, wherein inter-diffusion between the first ceramic layer material and the second ceramic layer material is prevented by using the diffusion barrier layer.

The low temperature co-fired ceramic substrate may further include vias formed through the first ceramic layer, the buffer layer, and the second ceramic layer in order; and at least two electrode patterns connected to one side of each of the vias, and provided on one or both surfaces of the first ceramic layer or the second ceramic layer.

The first ceramic layer may include a plurality layers provided along the vias in one surface direction, and the at least two electrode patterns are provided on one or both surfaces of the first ceramic layer.

The second ceramic layer may include a plurality of layers provided along the vias in one surface direction, and the at least two electrode patterns are provided on one or both surfaces of the second ceramic layer.

The buffer barrier layer may further include any one selected from a silicate glass group consisting of BaO—CaO—SiO₂-based glass, BaO—Al₂O₃—SiO₂-based glass, B₂O₃—SiO₂-based glass, CaO—MgO—SiO₂-based glass, and Al₂O₃—CaO—SiO₂-based glass, or a combination thereof.

The diffusion barrier layer may include the Ba content higher than an adjacent layer by 5 to 20 mol %.

The Ba compound may be BaTiO₃.

The diffusion barrier layer may have the same thickness as the first ceramic layer or the second ceramic layer.

According to another aspect of the present invention, there is provided a method of manufacturing a low temperature co-fired ceramic substrate, the method including: preparing at least one base material layer including a ceramic material, a silicate glass material, and a barium (Ba) compound; forming a first ceramic layer formed of a material having a first dielectric constant and a second ceramic layer formed of a material having a second dielectric constant lower than the first dielectric constant, the first and second ceramic layers each having at least two electrode patterns each on upper and lower surfaces of the base material layer; and forming a low temperature co-fired ceramic substrate having the base material layer serving as a diffusion barrier layer by firing a laminated structure including the base material layer and the first and second ceramic layers.

The preparing the base material layer may include: applying slurry including the silicate glass material, the barium (Ba) compound, a dispersant, and a binder onto an upper surface of a carrier film; curing the applied slurry to form the base material layer to form the base material layer; and removing the carrier film.

The silicate glass material may include any one selected from the group consisting of BaO—CaO—SiO₂-based glass, BaO—Al₂O₃—SiO₂-based glass, B₂O₃—SiO₂-based glass, CaO—MgO—SiO₂-based glass, and Al₂O₃—CaO—SiO₂-based glass, or a combination thereof.

In the preparing the base material layer, the base material layer may include the Ba content higher than an adjacent layer by 5 to 20 mol %.

The forming the low temperature co-fired ceramic substrate may include forming a via through the base material layer and one side of the electrode patterns formed on the first ceramic layer or the second ceramic layer before firing the laminated structure.

In the forming the ceramic layers, the first ceramic layer may include a plurality of layers provided on one surface of the base material layer, and the second ceramic layer may include a plurality of layers provided on the other surface of the base material layer.

The barium (Ba) compound may be BaTiO₃.

The base material layer serving as the diffusion barrier layer may have the same thickness as the first ceramic layer or the second ceramic layer

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is an exemplary view illustrating a diffusion barrier layer that is formed in a low temperature co-fired ceramic substrate according to the related art;

FIG. 2 is a cross-sectional view illustrating the configuration of a low temperature co-fired substrate according to an exemplary embodiment of the present invention; and

FIGS. 3A through 3C are cross-sectional views illustrating the process flow of a method of manufacturing a low temperature co-fired ceramic substrate according to an exemplary embodiment of the present invention.

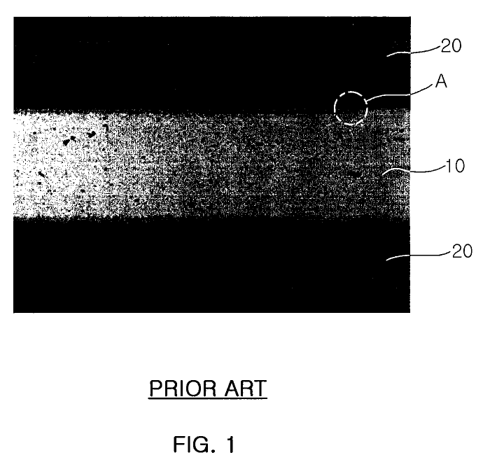

### DETAILED DESCRIPTION OF THE PREFERRED EMBODIMENT

Exemplary embodiments of the present invention will now be described in detail with reference to the accompanying drawings.

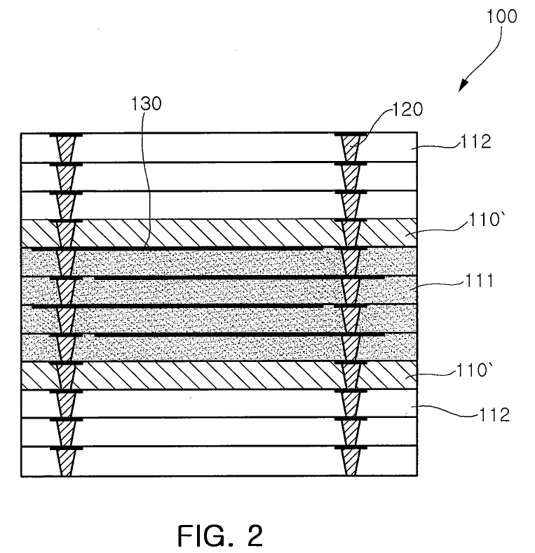

FIG. 2 is a cross-sectional view illustrating a low temperature co-fired ceramic substrate according to an exemplary embodiment of the invention.

As shown in FIG. 2, a low temperature co-fired ceramic substrate 100 according to an exemplary embodiment of the invention includes a plurality of first ceramic layers 111 having a first dielectric constant, a plurality of second ceramic layers 112 having a second dielectric constant lower than the first dielectric constant, diffusion barrier layers 110′, vias 120 formed through the ceramic layers 111 and 112 and the diffusion barrier layers 110′, and a plurality of electrode patterns 130. Here, each of the diffusion barrier layers 110′ is provided between the first ceramic layers 111 and the second ceramic layers 112 so as to prevent ion diffusion in a heterojunction between the first ceramic layers 111 and the second ceramic layers 112. The plurality of electrode patterns 130 are formed on both surfaces of each of the first and second ceramic layers 111 and 112 to form capacitors and are respectively connected to the vias 120.

The first ceramic layer 111 includes, for example, Bi, Ba, and SiO₂ is a layer having a high dielectric constant with a first thermal expansion coefficient of approximately 12 to 13. Further, while the first ceramic layer 111 includes at least two electrode patterns 130 on an upper or lower surface thereof, the electrode patterns 130 are connected to the vias 120 to form the capacitor.

The second ceramic layer 112 includes, for example, Ca, Al, and SiO₂. Further, the second ceramic layer 112 has a second thermal expansion coefficient of approximately 5 to 10 lower than the first thermal expansion coefficient. The second ceramic layer 112 has a dielectric constant lower than the first ceramic layer 111. Like the first ceramic layer 111, while the second ceramic layer 112 includes at least two electrode patterns 130 on an upper or lower surface thereof, the electrode patterns 130 are connected to the vias 120 to form the capacitor.

In order to prevent the formation of the diffusion layer A due to ion diffusion in the heterojunction in the related art, the diffusion barrier layer 110′ is formed in the heterojunction of the first ceramic layer 111 and the second ceramic layer 112 by compounding materials of the first ceramic layer 111 and the second ceramic layer 112. For example, the diffusion barrier layer 110′ may include silicate glass containing any one of BaO—CaO—SiO₂-based glass, BaO—Al₂O₃—SiO₂-based glass, B₂O₃—SiO₂-based glass, CaO—MgO—SiO₂-based glass, and Al₂O₃—CaO—SiO₂-based glass, or a combination thereof, and a filler of BaTiO₃.

Here, the diffusion barrier layer 110′ may have the Ba content higher than the first ceramic layer 111 by 5 to 20 mol %, and may have the same thickness as the first ceramic layer 111 or the second ceramic layer 112.

The vias 120 are formed through the low temperature co-fired ceramic substrate 100, and are filled with a conductive material, such as metal. The via 120 is connected to the at least two electrode patterns 130 that are formed on one or both surfaces of each of the first ceramic layer 111 and the second ceramic layer 112. The via 120 forms the capacitor along with each of the first and second ceramic layers 111 and 112 provided between the electrode patterns 130.

Further, a bonding material (not shown) is provided on an exposed upper or lower part of the via 120 so as to mount an arbitrary device (not shown).

The low temperature co-fired ceramic substrate 100 according to this embodiment uses the diffusion barrier layers 110′ formed by compounding the material of the first ceramic layer 111 and the material of the second ceramic layer 112, and having the Ba content higher than the first ceramic layer 111 by 5 to 20 mol %. The diffusion barrier layers 110′ are used to prevent ion diffusion of the materials of the first ceramic layer 111 and the second ceramic layer 112 into each other.

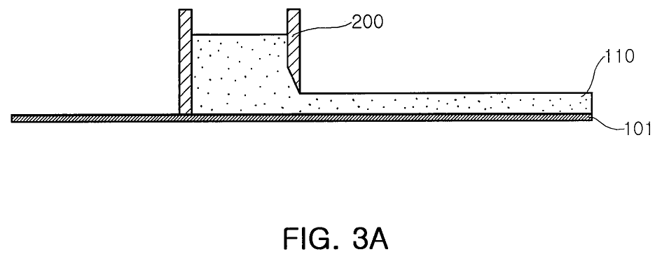

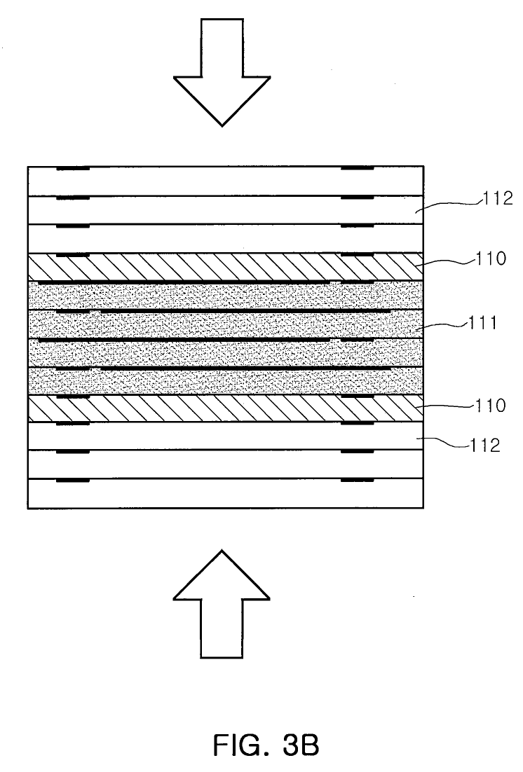

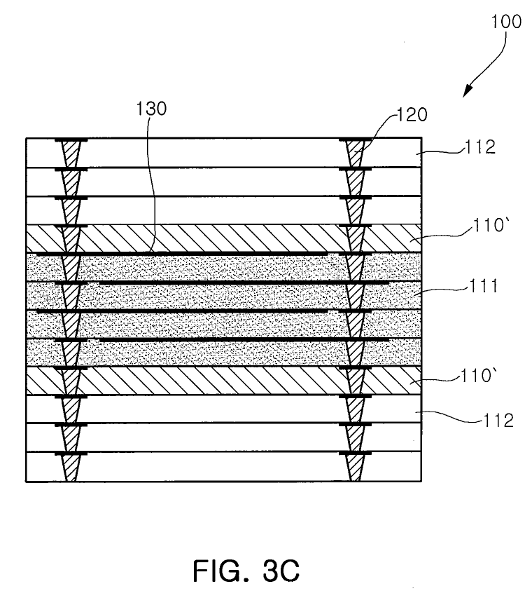

Hereinafter, a method of manufacturing a low temperature co-fired ceramic substrate 100 according to an exemplary embodiment of the invention will be described with reference to FIGS. 3A through 3C.

First, shown in FIG. 3A, a base material layer 110 used to form a diffusion barrier layer 110′ is formed on an upper surface of a carrier film 101, such as a mylar film, so as to manufacture a low temperature co-fired ceramic substrate 100 according to an exemplary embodiment of the invention.

Specifically, as shown in FIG. 3A, the base material layer 110 used to form the diffusion barrier layer 110′ is formed from a compound of materials of a first ceramic layer 111 and a second ceramic layer 112, and slurry containing one component selected from a silicate glass group consisting of BaO—CaO—SiO₂-based glass, BaO—Al₂O₃—SiO₂-based glass, B₂O₃—SiO₂-based glass, CaO—MgO—SiO₂-based glass, and Al₂O₃—CaO—SiO₂-based glass, and a combination thereof, a barium compound of BaTiO₃ as a filler, a dispersant for dispersing a silicate-based glass component and the filler of the barium compound, and a binder. The slurry is cast onto the upper surface of the carrier film 101 by using a doctor blade 200, and then cured.

After the base material layer 110 to form the diffusion barrier layer 110′ is cured, as shown in FIG. 3B, the carrier film 101 attached to the base material layer 110 is removed to provide the base material layer 110. The plurality of first ceramic layer 111 containing, for example, Bi, Ba, and SiO₂, and having a high dielectric constant, and the plurality of second ceramic layers 112 containing Ca, Al, and SiO₂ and having a low dielectric constant lower than the first ceramic layer 111 are bonded to the upper and lower surfaces of each of at least two base material layers 110. The plurality of first ceramic layer 111 and the plurality of second ceramic layer 112 are subjected to isostatic pressure to form a laminated structure.

Then, vias 120 are formed in the laminated structure including the first ceramic layers 111, the base material layers 110, and the second ceramic layers 112, and then the laminated structure is fired at low temperature. As shown in FIG. 3C, the material of the first ceramic layer 111 and the material of the second ceramic layer 112 are compounded to a manufacture the low temperature co-fired ceramic substrate 100 including the diffusion barrier layers 110′ having the Ba content higher than the first ceramic layer 111 by 5 to 20 mol %.

Specifically, the plurality of first ceramic layers 111 are bonded to one surface of each of the at least two base material layers 110, and the plurality of second ceramic layers 112 are bonded to the other surface of each of the base material layers 110. Here, the vias 120 and the electrode patterns 130 are formed on each of the first ceramic layer 111 and the second ceramic layer 112. The electrode patterns 130 formed on one or both surfaces of each of the first and second ceramic layers 111 and 112 are connected to one side of the through via 120. As the vias 120 of the plurality of ceramic layers 111 and 112 are connected to each other, the plurality of ceramic layers 111 and 112 can be coupled to each other.

Alternatively, after the plurality of ceramic layers 111 and 112 having the electrode patterns 130 formed on one or both surfaces thereof are formed on both surfaces of the base material layer 110, the vias 120 may be collectively formed through the plurality of ceramic layers 111 and 112 and the base material layer 110.

After the plurality of ceramic layers 111 and 112 having the vias 120 and the electrode patterns 130 are bonded to both surfaces of each of the base material layers 110, a firing process is performed at a low temperature of approximately 300 to 1000° C., for example. That is, as shown in FIG. 3C, the material of the first ceramic layer 111 and the material of the second ceramic layer 112 are compounded, thereby manufacturing the low temperature co-fired ceramic substrate 100 including the diffusion barrier layer 110′ having the Ba content higher than the first ceramic layer 111 by 5 to 20 mol %.

Therefore, the process of manufacturing the low temperature co-fired ceramic substrate 100 prevents the formation of the diffusion layer A at the heterojunction in the related art due to diffusion of the ions inside the materials of the first ceramic layer 111 and the second ceramic layer 112, and thus prevents a decrease in dielectric constant of the first ceramic layer 111 having the high dielectric constant. Accordingly, the low temperature co-fired ceramic substrate 100 having the improved reliability can be provided.

As set forth above, according to exemplary embodiments of the invention, the generation of defects, such as diffusion layers, caused by ion diffusion in the junction of a first ceramic layer having a high dielectric constant and a second ceramic layer having a second dielectric constant during firing can be prevented, and thus a decrease in dielectric constant of the first ceramic layer having the high dielectric constant in the related art can be prevented, thereby providing a low temperature co-fired ceramic substrate having improved reliability.

While the present invention has been shown and described in connection with the exemplary embodiments, it will be apparent to those skilled in the art that modifications and variations can be made without departing from the spirit and scope of the invention as defined by the appended claims.

What is claimed is:

1. A low temperature co-fired ceramic substrate comprising:
a first ceramic layer formed of a material having a first dielectric constant;
a second ceramic layer formed of a material having a second dielectric constant lower than the first dielectric constant; and
a diffusion barrier layer interposed between the first ceramic layer and the second ceramic layer and formed of the first ceramic layer material, the second ceramic layer material, and a barium (Ba) compound,
wherein inter-diffusion between the first ceramic layer material and the second ceramic layer material is prevented by using the diffusion barrier layer.

2. The low temperature co-fired ceramic substrate of claim 1, further comprising:
vias formed through the first ceramic layer, the buffer layer, and the second ceramic layer in order; and
at least two electrode patterns connected to one side of each of the vias, and provided on one or both surfaces of the first ceramic layer or the second ceramic layer.

3. The low temperature co-fired ceramic substrate of claim 2, wherein the first ceramic layer comprises a plurality layers provided along the vias in one surface direction, and the at least two electrode patterns are provided on one or both surfaces of the first ceramic layer.

4. The low temperature co-fired ceramic substrate of claim 2, wherein the second ceramic layer comprises a plurality of layers provided along the vias in one surface direction, and the at least two electrode patterns are provided on one or both surfaces of the second ceramic layer.

5. The low temperature co-fired ceramic substrate of claim 1, wherein the buffer barrier layer further comprises any one selected from a silicate glass group consisting of BaO—CaO—SiO₂-based glass, BaO—Al₂O₃—SiO₂-based glass, B₂O₃—SiO₂-based glass, CaO—MgO—SiO₂-based glass, and Al₂O₃—CaO—SiO₂-based glass, or a combination thereof.

6. The low temperature co-fired ceramic substrate of claim 1, wherein the diffusion barrier layer comprises the Ba content higher than an adjacent layer by 5 to 20 mol %.

7. The low temperature co-fired ceramic substrate of claim 1, wherein the Ba compound is BaTiO₃.

8. The low temperature co-fired ceramic substrate of claim 1, wherein the diffusion barrier layer has the same thickness as the first ceramic layer or the second ceramic layer.

9. A method of manufacturing a low temperature co-fired ceramic substrate, the method comprising:
preparing at least one base material layer including a ceramic material, a silicate glass material, and a barium (Ba) compound;
forming a first ceramic layer formed of a material having a first dielectric constant and a second ceramic layer formed of a material having a second dielectric constant lower than the first dielectric constant, the first and second ceramic layers each having at least two electrode patterns each on upper and lower surfaces of the base material layer; and
forming a low temperature co-fired ceramic substrate having the base material layer serving as a diffusion barrier layer by firing a laminated structure including the base material layer and the first and second ceramic layers.

10. The method of claim 9, wherein the preparing the base material layer comprises:
applying slurry including the silicate glass material, the barium (Ba) compound, a dispersant, and a binder onto an upper surface of a carrier film;
curing the applied slurry to form the base material layer to form the base material layer; and
removing the carrier film.

11. The method of claim 9, wherein the silicate glass material comprises any one selected from the group consisting of BaO—CaO—SiO₂-based glass, BaO—Al₂O₃—SiO₂-based glass, B₂O₃—SiO₂-based glass, CaO—MgO—SiO₂-based glass, and Al₂O₃—CaO—SiO₂-based glass, or a combination thereof.

12. The method of claim 9, wherein in the preparing the base material layer, the base material layer comprises the Ba content higher than an adjacent layer by 5 to 20 mol %.

13. The method of claim 9, wherein the forming the low temperature co-fired ceramic substrate comprises forming a via through the base material layer and one side of the electrode patterns formed on the first ceramic layer or the second ceramic layer before firing the laminated structure.

14. The method of claim 9, wherein in the forming the ceramic layers, the first ceramic layer comprises a plurality of layers provided on one surface of the base material layer, and the second ceramic layer comprises a plurality of layers provided on the other surface of the base material layer.

15. The method of claim 9, wherein the barium (Ba) compound is BaTiO₃.

16. The method of claim 9, wherein the base material layer serving as the diffusion barrier layer has the same thickness as the first ceramic layer or the second ceramic layer.
